(19) United States
(12) Patent Application Publication
(10) Pub. No.: US 2025/0054381 A1
(43) Pub. Date: Feb. 13, 2025

(54) DEFENDANT TRACKING AND NOTIFICATION SYSTEM

(71) Applicants: Trevor KYLE, Lake Charles, LA (US); Michael ANTOON, Lake Charles, LA (US)

(72) Inventors: Trevor KYLE, Lake Charles, LA (US); Michael ANTOON, Lake Charles, LA (US)

(21) Appl. No.: 18/446,594

(22) Filed: Aug. 9, 2023

(51) Int. Cl. G08B 21/22; G06F 21/32; G06Q 50/26; G06V 40/12; G06V 40/16; G06V 40/18; H04W 4/021; H04W 4/029

(52) U.S. Cl. CPC G08B 21/22; G06F 21/32; G06Q 50/26; G06V 40/1365; G06V 40/172; G06V 40/197; H04W 4/021; H04W 4/029

(57) ABSTRACT

A defendant notification and tracking system automatically notifies defendants of legal events and confirms notices of these legal events and monitors the defendant's location. The defendant notification and tracking system enables better compliance with defendants appearing for legal events and includes a plurality of interactive components that enable effective notification of a legal event to a defendant and location monitoring of the defendant by a global positioning system (GPS). The notification and tracking system includes a computer system including a computer that operates a system software. The defendant has a system application software that operates on their mobile device and interfaces with the computing system through a wireless signal. The defendant receives legal event notices electronically sent by the computing system on their mobile device. In the event the defendant does not show up for a legal event, authorities may be notified of the defendant's location.

### BACKGROUND OF THE INVENTION

### Field of the Invention

The invention relates to defendant tracking and notification system.

### Background

The current way the criminal justice system collects information on criminal defendants released on bail, notifies defendants of court appearances, monitors their whereabouts between court appearances, and addresses their failure to appear at those court dates is disjointed, antiquated, inefficient, and begs for a single, modern system which effectively and efficiently juggles the myriad tasks associated with these endeavors.

The United States and all state constitutions include a right to reasonable bail for criminal defendants. The purpose of the bail system is to ensure that a criminal defendant who has been arrested for a crime but who is presumed innocent until proven otherwise is not prematurely imprisoned while he awaits trial. So long as the criminal justice system and constitution(s) exist, so will there exist the need to release defendants on bail, notify them of future court dates, monitor them to ensure that they appear for those dates, and to address the inevitable failure of some to appear. There is virtually no mechanism to guarantee a defendant's appearance short of continued incarceration However, the bail system facilitates the release of a defendant and incentivizes his appearance by requiring that the defendant put up security prior to being released on bail and losing that security if he does not appear in court. Judges can also impose other conditions to make a defendant's appearance more likely. These conditions are chosen and tailored based on the circumstances specific to the defendant and the relative risk that he may fail to appear.

The rules, processes, considerations, and application of the bail bond system are largely consistent and/or similar throughout the United States. Persons booked into jail will typically only be released by satisfying a bail obligation, the amount of which depends on a variety of factors that include but are not limited to past criminal history, nature and severity of the crime, potential danger to the community posed by the defendant's release, risk of flight, history of nonappearance in prior/other criminal prosecutions, etc. The subjective proclivities of the Judge setting bail also play a part in a bail amount.

Defendants may satisfy the bail obligation by directly depositing the full amount with the jail, by paying a smaller, nonrefundable fee to a commercial bondsman to deposit the full amount (otherwise known as a “commercial bond”), or to agree to a lien being placed on immovable property (land) in that amount (otherwise known as a “property bond”). For a property bond to be acceptable, the owner of the property must have sufficient equity based on the Parish/County tax assessment to meet or exceed the amount. At the conclusion of the case, the full amount of bail is returned to he/she who advanced it or the property lien is released, as the case may be. Conversely, the funds/property advanced for bail to secure the defendant's appearance is forfeited if the defendant does not appear and does not timely remedy his failure to appear.

By far, the most common method of making bail is through a commercial bondsman. This is because defendants often do not have enough equity in property or liquid cash to pay the full amount of bail. Commercial bondsman, as an agent for a surety (similar to an insurance agent to an insurance company), deposits the full amount of the bail obligation on behalf of the defendant to secure the defendant's release. The bondsman charges a non-refundable fee, typically fixed by law as a percentage of the full bail amount (12% of the bail obligation in Louisiana). This 12% is profit. Keep in mind, bondsmen do not keep all 12% as profit but must divvy among several parties. The bondsman must deposit a certain percentage in a “buffer account” which accumulates over-time and is used to repay the surety if a bail is forfeited on a defendant who fails to appear. A percentage is also paid to the sheriff and to the surety who fronted the bail obligation.

When a defendant fails to appear, the bail amount deposited by the bondsman on behalf of the surety is forfeited. The bondsman must then repay the surety from his buffer account, assuming the account is sufficiently funded to repay the forfeiture. He must then dedicate money from future profits to refund the buffer account and/or repay the surety.

At the heart of commercial bonding is risk management. Because commercial bonding is a “risky business”, this industry is typically regulated by the respective State's department of insurance or similar state administrative agency.

The methods by which Defendants are currently notified of court appearances are outdated, inefficient, and unreliable. Currently, criminal defendants provide contact information to the jail/facility from which they are released on bail. These defendants often have loose, unstable, and erratic living arrangements, unpredictable and volatile social/familial connections, and other changing circumstances. This makes them harder to locate as time passes during the course of a criminal prosecution and as the contact information originally provided to the facility upon release becomes staler. Sometimes defendants intentionally fail to appear to evade conviction and/or punishment.

The diminishing likelihood that a non-appearing defendant can be timely found as time passes is a problem for all interested parties in the criminal justice system. Judges and prosecutors cannot dispose of cases when the defendant fails to appear which impedes their ability to whittle away at already overcrowded caseloads and dockets. When non-appearing defendants are apprehended or appear later on their own initiative, more court time is inefficiently wasted with evidentiary hearings conducted to determine the reason and/or appropriate punishment for the non-appearance. These hearings rob the court of time that it could otherwise spend addressing the ordinary business of the court. During these hearings, one of the most common excuses that defendants give for failing to appear is that they did not receive notice of the court date in the mail. Sometimes, that's the truth.

Clerks of Court/Sheriffs do not typically send court notices via certified mail due to the cost. As we all know, mail can get lost or delivered to the wrong address. What's more, there is never a guarantee that the defendant personally receives the mail even if it is delivered to the correct address because family members or roommates might intercept the notice and forget to pass it along. Also, many defendants do not consistently reside at the same address they provide to the facility from which they bond nor do they take initiative to update their address with that facility. To streamline or possibly obviate the need for evidentiary hearings to determine the reason for non-appearance, clerks of court, judges and prosecutors have an interest in verifying with certainty that the defendant receives and confirms notice of the court date to eliminate any excuse that the defendant did not receive notice and was therefore not aware of the court date.

Sheriff's, who have teams that locate and apprehend defendants who fail to appear, are served by having the most reliable and recent contact/location information possible. This increases the likelihood that they apprehend the defendant or at least gain information from acquaintances on his whereabouts. Such information expedites apprehension and decreases the costs and resources associated with it. Bondsmen are also served by Sheriffs timely apprehending these defendants because, in most states, the bail amount is not forfeited if the defendant is apprehended within a certain period of time after failing to appear.

Bail bondsman have a profound interest in ensuring that their defendants: 1) receive notice of pending court appearances, 2) confirm receipt of notices of court appearance, 3) can refer to an easily accessible calendar or resource to determine/remind themselves of court appearances, and 4) to find defendants who fail to appear.

Currently, bondsmen, particularly those with no or limited staff, are burdened with manually checking-in with, monitoring, and notifying defendants of up-coming court dates to incentivize appearance and protect their risky investment. Bondsmen must personally monitor the calendar, retrieve contact information, and manually call or text the defendant in advance of court dates and follow-up, perhaps in-person, if there is no response. A bondsman may require that certain defendants personally appear from time to time to prove that they are still local. Bondsmen must triage these activities by the level of risk associated with each defendant's potential failure to appear.

As one might expect, criminal defendants are not always the most responsible or trustworthy persons. Some defendants fail to appear due to negligence and others because they specifically intend to evade the court. Though all of the parties noted in the preceding section have significant interests in ensuring that defendants receive and confirm notice of court dates, bondsman may have the most profound interest. Judges, prosecutors, Clerks of Court, and Sheriffs, all established by law and sustained by virtually guaranteed funding, still exist despite non-appearance, though inconvenienced by it. However, a single bond-forfeiture can be financially catastrophic for a bondsman, the only private entity interested in the matter, and even bankrupt him if he does not have sufficient funds in his buffer account to cover the forfeiture OR must dedicate future profits to refund the buffer account.

### SUMMARY OF THE INVENTION

The invention is directed to a defendant notification and tracking system that automatically notifies defendants of legal events and confirms notices of these legal events and monitors the defendant's location.

The defendant notification and tracking system is an innovative system that was conceived and will be implemented in large part by professionals with decades of combined experience in various capacities within the criminal justice system. The defendant notification and tracking system will enable better compliance with defendants appearing for legal events which will greatly improve the legal system and make it more efficient. Various parties will realize the benefits of this system including, but not limited to, bail bondsmen, law enforcement, clerks of court, Judges, and defendants, persons on bail for criminal. With respect to all, this product will utilize-technological tools and applications in a novel way to more efficiently and effectively satisfy existing and perpetually recurring critical needs that are currently serviced by old-fashioned and less reliable methods and mechanisms.

An exemplary embodiment of the defendant notification and tracking system will primarily serve commercial bail bondsmen but will also provide utility and convenience to criminal defendants released on bail. Bail bondsmen will require that defendants download an system application software onto their smart phones and will collect biographical, identification, contact, and other data from defendants upon contracting to provide services to them. Existing bail contracts, like any business contract, already impose obligations on each party and rights of recourse upon breach of those obligations. A good bail contract will obligate the defendant to stay in touch with the bondsman, respond to communications, update the bondsman on changes in address and contact information, and to appear for legal events as required. In the most severe circumstance, the bail bondsman may void the contract, retrieve the bail deposit and surrender the defendant back to jail if the defendant fails to fulfill the obligations of the contract. This is known as a bondsman “getting off the bond”.

Bail bondsmen that utilize the defendant notification and tracking system can easily include in the contract that the defendant agrees to use defendant notification and tracking system accordingly, to pay any associated fees, and to allow the bail bondsman to release pertinent data to interested law enforcement, prosecutorial and judicial entities/agencies upon breach of contract, such as failure to confirm a notification, or non-appearance for a legal event. The bail bondsmen may, under the contract, share data including location data of the defendant with law enforcement for non-compliance with the contract. The defendant's location may be tracked by the system application software in combination with a global positioning system (GPS0). The bail bondsman may be able to log into a computer program or system application software and monitor the defendant's location at any time, or the location of the defendant may be determined and logged each time the defendant interfaces with the system application software. The defendants location may be stored in the computer system for future reference and may be provided to law enforcement.

The defendant may be required to notify the bail bondsman should there be any change in residence. Also, the defendant notification and tracking system may alert the bail bondsman and/or law enforcement if the defendant travels outside of a designated area. The system may set a threshold area within which the defendant must remain until a legal event results in a change or elimination of this area restriction. The system may track a defendant's location through a global positioning system on the defendant mobile device, such as a mobile phone and the system may be notified when the defendant has moved outside of a threshold area. A threshold area may be the boundary of a state of the United States or other country, a county within a state, a city limit area, a country boundary and the like. The defendant may receive a notice on the defendant mobile device should they move outside of a threshold area. A defendant may be provided bail under the agreement that they stay within the state or county, for example, and if the defendant travels outside of this contractual and/or legal boundary, their location may be provided to the bail bondsman and/or law enforcement.

The defendant notification and tracking system will automatically notify defendants of legal event dates, such as court dates, counseling appointments, hearings and the like. The legal event details and dates may be sent to the defendant's mobile device and they may be required to confirm receipt of this notice and affirm compliance with attending the legal event within a certain time frame, such as within 24 hours.

A mobile device may be a smartphone and for defendants that do not have a mobile device, the bail bondsman may provide one as part of the contract to the defendant. The computer program of the system may interface with one or more legal agencies and my retrieve legal event dates automatically and send these dates to the bail bondsman as well as to the defendant on their mobile device through the system application software. The dates may also be monitored by the bail bondsman and input into the computer system. The computer system may automatically send a notice to the defendant upon entry of a legal event date or updating a legal event date into the computer system.

Using the defendant notification and tracking system, bail bondsmen will be able to input court dates along with information pertinent to each defendant and his case including docket numbers, charges, jurisdiction, court, address, date and time of the appearance, and the like. The defendant notification and tracking system may periodically and at predetermined intervals notify and remind the defendant of that information and immediately prompt the defendant to confirm receipt of the notice upon viewing. The defendant notification and tracking system will document the confirmation. This saves the bail bondsman from having to personally monitor or manually notify and document notice and confirmation.

The defendant notification and tracking system will also help the defendants to keep track of important legal event dates. The system application software may include a calendar or interface with a calendar on the mobile device and may automatically populate the calendar with the legal event dates. Furthermore, the system application software may automatically remind the defendant of legal event dates and send out reminders for confirmation, such as one week in advance, three days in advance, two days in advance, one day in advance, the day off and two hours in advance, for example. Each time a reminder is posted on the defendant's mobile device, the defendant may have to confirm and their location may be recorded by the system. The defendant may open the calendar at any time and view when the legal event dates are. Providing the calendar and these notifications will greatly decrease the number of instances where a defendant forgets or mistakes a legal event date, such as a court date.

At present, most defendants are mailed or hand-served paper notices of future court dates. These are often lost or discarded. Many defendants fail to record these dates on an electronic calendar much less set reminders and notices in advance of the date to prompt them to appear. The defendant notification and tracking system may also automatically populate all pertinent information concerning the legal event date and reason therefore onto the calendar. The system application software may also provide other information about the legal event, including requirement for the event, such as any charges, docket number, court address, attire required, documents required for entry, reminder of prohibited items for admission to the legal event and the like. This information may be particularly useful for defendants who have open charges in multiple courts and/or jurisdictions (i.e., various counties or municipal and county courts) which increases the likelihood that they get wires crossed on court dates and locations.

The defendant notification and tracking system may utilize passwords/pins to certify that it was the defendant who personally received and confirmed notice of court dates. The application software may require some additional confirmation that the defendant is interfacing with the system, such as taking a picture of themselves with the mobile device when confirming receipt of a notification of a legal event. The digital photograph would be date and time stamped and may be stored on the computer system of the defendant notification and tracking system. An advanced defendant notification and tracking system may use biometric data input to confirm that the defendant is interfacing with the system. The biometric confirmation may be the most accurate way to confirm the identity of defendant operating their smart phone but is more expensive. A defendant may provide confirmation of receipt of a notice of a legal event through a biometric input to the defendant mobile device. The defendant may speak into a microphone and the speech may be analyzed through voice recognition on the defendant mobile device and/or the computer system. The defendant may have a picture taken of their face or eye and this picture may be analyzed using face or eye recognition software, again on the defendant mobile device and/or the computer system. A defendant mobile device may have a fingerprint device configured to scan a fingerprint of the defendant.

When a defendant voluntarily appears following a failure to appear or is apprehended, the court must conduct an evidentiary hearing to determine if the defendant is in contempt of court for failing to appear. The most common excuses, all rooted in plausible deniability, are that the defendant moved addresses and failed to update the court/jail, that notice went to the correct address but someone else intercepted it or the defendant simply overlooked the notice, or that the defendant simply forgot or mistook the court date. Cumulatively, these hearings waste days and perhaps weeks of valuable court time over the course of a year.

The defendant notification and tracking system will eliminate a defendant argument that they did not receive the notification of a legal event date. The defendant will have to confirm receipt one or more times of a legal event date and therefore, missed court event dates will be reduced. This will increase efficiency in the system which is a paramount concern for all prosecutors in judges in all jurisdictions.

If a defendant fails to appear for a legal event, law enforcement may use the defendant notification and tracking system and the GPS location data of the defendant to locate and apprehend the defendants who fail to appear. Law enforcement may also have an interface with the defendant notification and tracking system to view location data from confirmations that are logged throughout the criminal proceeding.

Table 1 provides a list of functions of various parties interested/involved in criminal proceedings, problems and inefficiencies they experience in discharging those functions or that they experience due to non-appearance, as well as how the defendant notification and tracking system will mitigate or obviate those problems.

TABLE 1

| | | | Benefit of |
|---|---|---|---|
| Party | Function | Problem | Release 360 |
| Judges | Order court | Unable to dispose | 360 will send |
| | dates | of cases on | electronic notice |
| | Conduct | docket due to | to the record |
| | evidentiary | non-appearance | when a defendant |
| | hearings to | Waste time | acknowledges |
| | determine | conducting | receipt of a court |
| | whether a | evidentiary | date. This will |
| | non-appearing | hearing to | all but eliminate |
| | defendant is | determine the | a defendant's |
| | in contempt | reasons for non- | ability to deny |
| | and levies | appearance and | that he or |
| | an appropriate | levying the | she received |
| | punishment | appropriate | notice and |
| | | punishment for | streamline |
| | | the same | evidentiary |
| | | | hearings on the |
| | | | topic. The |
| | | | cumulative effect |
| | | | will be an |
| | | | increase in |
| | | | efficiency of the |
| | | | court system. |
| Clerks of Court | Generates and | Requires | Clerks can input |
| | sends | manpower and | appearance |
| | notice of | costs associated | information into |
| | court dates | with generating | 360 which will |
| | via US mail | and printing | automatically |
| | | notices, stuffing | send notice and |
| | | and mailing | document |
| | | envelopes | confirmation of |
| | | Relies on USPS | the notice through |
| | | to unerringly | the app without |
| | | deliver the notices | the need for |
| | | Cannot guarantee | paper, envelopes, |
| | | that defendant | postage, etc. This |
| | | still resides | also increases the |
| | | at that | likelihood that the |
| | | address | defendant will |
| | | Cannot guarantee | personally receive |
| | | that others who | the notice. |
| | | reside there do | |
| | | not intercept the | |
| | | notice and fail | |
| | | to advise the | |
| | | defendant of the | |
| | | notice and/or | |
| | | new court date. | |
| Law | Spend time, | Contact | Law enforcement |
| enforcement | resources, | information, | can evaluate |
| | and manpower | addresses for | location data from |
| | to pursue, | work and | several “check- |
| | find and | residence are | ins” leading |
| | detain | often stale | up to the non- |
| | defendants | making | appearance to |
| | who fail | it difficult | find more recent |
| | to appear | for law | locations where |
| | Must | enforcement | the defendant |
| | investigate | to track | may have lived, |
| | and deal | down and detain | worked, |
| | with crimes | defendants | frequented, and |
| | committed | who fail | generate leads on |
| | by defendants | to appear | the current |
| | who commit | | whereabouts of |
| | more crimes | | the defendant. |
| | while evading | | |
| | pending charges | | |
| | before a court. | | |

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a diagram of an exemplary notification and tracking system including a defendant mobile device that the defendant interfaces with to confirm legal event notifications and wherein the defendant's location is monitored by a global positioning system (GPS).

FIG. 2 shows a defendant mobile device with a legal event notice and confirmation input requirement.

FIG. 3 shows a bail bondsman's computing device interfacing with a law enforcement computing device to provide a location of a defendant for apprehension.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations, and improvements of the described embodiments, will occur to those skilled in the art and all such alternate embodiments, combinations, modifications, improvements are within the scope of the present invention.

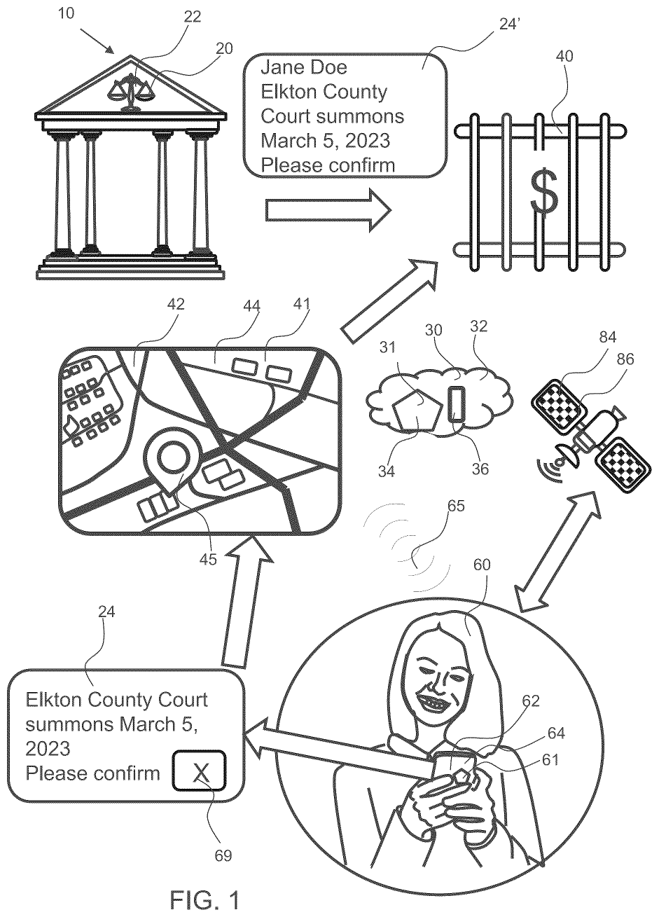

As shown in FIG. 1, an exemplary notification and tracking system 10 includes a plurality of interactive components that enable effective notification of a legal event to a defendant and location monitoring of the defendant by a global positioning system (GPS). The notification and tracking system includes a computer system 30 including a computer 34 that operates a system software 31 that may be part of a cloud computing system 32. The defendant 60 has a system application software 61 that operates on their mobile device 62 and interfaces with the computing system 30 through a wireless signal 65. The defendant has received a legal event notice 24 that may have been electronically sent or prepared as an electronic legal event notice 24′ by the computing system 30 operating a system computer program 31. The bail bondsman 40 may have retrieved the legal event from a legal event administrator 20, such as a court 22, and produced the legal event notice 24 using the bail bondsman computing device 42, such as a computer or mobile phone. The defendant is interfacing with the defendant's mobile device to confirm receipt of the legal event notice 24. A defendant confirmation 69 is input into the computing system and may be sent by a wireless signal 65 to be stored in a database 36. Also, the defendant's location may be determined by a defendant global positioning device 64 that interfaces with a global positioning system 86, that may incorporate a satellite 84 and/or cell-tower to determine the defendant's location. The defendant's location may be displayed on the bail bondsman's computing device 42 display 41 as a defendant location map 44, having a pin 45 to indicate the defendant's location. The location of the defendant may be provided any other suitable way however, such as by address or cross-roads, or quadrants.

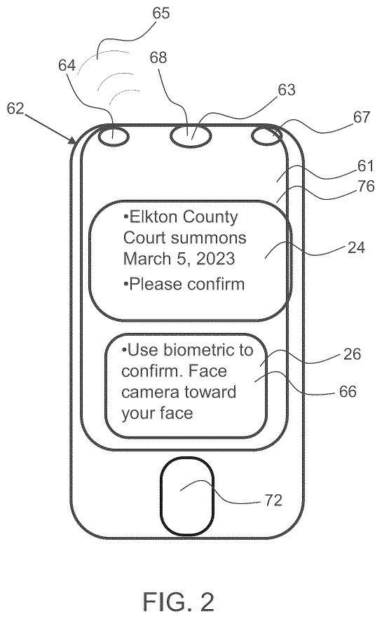

As shown in FIG. 2, a defendant mobile device 62 has a display 76 with a legal event notice 24 and confirmation input requirement 26. The defendant may use a user interface 66 to provide confirmation of the legal event notice 24. The notice of the legal event was received and is displayed by the system application software 61. The confirmation may require a biometric confirmation 63, such as a photograph or scan that uses the camera 68 to confirm the identity of the defendant, such as through facial recognition, a fingerprint, an eye scan and the like. The defendant mobile device 62 may have a fingerprint device 72 configured for fingerprint scanning or reading. Facial recognition and finger print scans are routinely used now to unlock a mobile phone and could be employed by the system application software to confirm the identity of the defendant. Also, speech recognition may be a biometric confirmation that requires the use of the microphone 67.

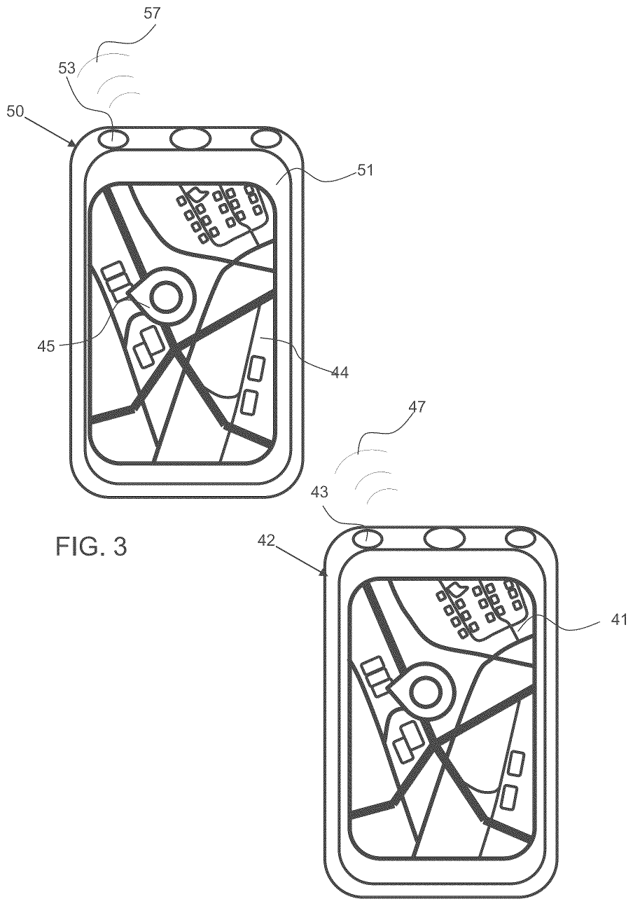

As shown in FIG. 3, a law enforcement computing device 50 has received a defendant location map 44 on their display 51 via a wireless signal 57 receive by their wireless transceiver 53 which may provide the law enforcement person with direction to the defendant's location. The defendant location map may include a pin 45 showing the location of the defendant. This map display may be interactive and the pin may move if the defendant is moving. The bail bondsman may send this defendant location map to the law enforcement computing device 50 from the bail bondsman computing device 42 via their wireless transceiver 43 that sends a wireless signal 47. This may be automatically sent when a defendant fails to appear for a legal event, such as a court hearing.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A notification and tracking system comprising:
a) a defendant mobile device retained by a defendant and comprising:
i) a global positioning system interface;
ii) a user input;
iii) a display;
b) a bail bondsman computing device operated by a bail bondsman;
c) a computer system configured to operate a system program that interfaces with the defendant mobile device and the bail bondsman computing device;
d) a global positioning system configured to determine a location of the defendant mobile device;
wherein a legal event notice is sent by the computer system to the defendant mobile device requesting confirmation of receipt of the legal event notice by the defendant; and
wherein the global positioning system determines said location of the defendant and relays this location to the bail bondsman computing device.

2. The notification and tracking system of claim 1, further comprising the defendant providing said confirmation of receipt of the legal event notice to the computer system with the defendant mobile device.

3. The notification and tracking system of claim 2, wherein the confirmation is a biometric input.

4. The notification and tracking system of claim 3, wherein the defendant mobile device further comprises a camera and wherein the biometric input is an eye scan taken by said camera of the defendant mobile device.

5. The notification and tracking system of claim 3, wherein the defendant mobile device further comprises a camera and wherein the biometric input is a photograph of said defendant's face taken by said camera of the defendant mobile device.

6. The notification and tracking system of claim 5, wherein the defendant mobile device further comprises facial recognition software configured to analyze the photograph of said defendant's face.

7. The notification and tracking system of claim 5, wherein the computer system further comprises facial recognition software configured to analyze the photograph of said defendant's face.

8. The notification and tracking system of claim 3, wherein the defendant mobile device further comprises a finger print device and wherein the biometric input is a finger print taken by said finger print device of the defendant mobile device.

9. The notification and tracking system of claim 3, wherein the defendant mobile device further comprises a microphone and wherein the biometric input is speech by said defendant received by said microphone.

10. The notification and tracking system of claim 9, wherein the defendant mobile device comprises voice recognition software configured to analyze the speed by said defendant.

11. The notification and tracking system of claim 5, wherein the computer system further comprises voice recognition software configured to analyze the speed by said defendant.

12. The notification and tracking system of claim 1, wherein the defendant mobile device comprises a global positioning device that interfaces with said global positioning system to determine a location of said defendant, and wherein said defendant is provided notification on the defendant mobile device when said defendant moves outside of a threshold area set by the notification and tracking system.

13. The notification and tracking system of claim 12, wherein the bail bondsman is provided notification when the defendant moves outside of a threshold area.

14. The notification and tracking system of claim 12, wherein the defendant mobile device comprises a global positioning device that interfaces with said global positioning system to determine a location of said defendant, and wherein the computer system is provided notification on the defendant mobile device when said defendant moves outside of a threshold area set by the notification and tracking system.

15. The notification and tracking system of claim 14, wherein the bail bondsman is provided notification when the defendant moves outside of a threshold area.

16. The notification and tracking system of claim 1, wherein the defendant mobile device comprises a global positioning device that interfaces with said global positioning system to determine a location of said defendant, and wherein the computer system is provided notification on the defendant mobile device when said defendant moves outside of a threshold area set by the notification and tracking system.

17. The notification and tracking system of claim 16, wherein the bail bondsman is provided notification when the defendant moves outside of a threshold area.

18. The notification and tracking system of claim 1, wherein the legal event is a court date.

19. The notification and tracking system of claim 1, wherein the legal event is a hearing.

20. The notification and tracking system of claim 1, wherein the legal event is a counseling appointment.
